(19) United States
(12) Patent Application Publication
(10) Pub. No.: US 2017/0075838 A1
(43) Pub. Date: Mar. 16, 2017

(54) QUALITY OF SERVICE IN INTERCONNECTS WITH MULTI-STAGE ARBITRATION

(71) Applicant: QUALCOMM Incorporated, San Diego, CA (US)

(72) Inventors: Prudhvi Nadh NOONEY, Raleigh, NC (US); Jaya Prakash Subramaniam GANASAN, Youngsville, NC (US)

(21) Appl. No.: 14/853,066

(22) Filed: Sep. 14, 2015

(51) Int. Cl. G06F 13/37; G06F 13/40; G06F 13/362

(52) U.S. Cl. CPC G06F 13/37; G06F 13/362; G06F 13/4004

(57) ABSTRACT

Techniques are disclosed to provide quality of service in bus interconnects with multi-stage arbitration. Source computing elements tag packets with a priority class and/or a number of credits that are based on a distance to a destination computing element of the packets. Arbiters controlling access to the bus interconnect perform arbitration operations to serve packets having higher relative priority based on the priority levels and/or numbers of credits of each packet.

### BACKGROUND

Aspects disclosed herein relate to the field of bus interconnects (also referred to herein as a “bus” or an “interconnect”). More specifically, aspects disclosed herein provide quality of service in bus interconnects with multi-stage (also referred to as multi-level) arbitration.

Components in integrated circuits, such as processors, memory, and caches, are conventionally connected via a bus interconnect. Modern interconnects include data transmissions paths in multiple dimensions (such as the x-, y-, and z-dimensions), and routing packets from a source to its destination along the interconnect involves arbitration in various stages by a number of different arbiters. Applying fair arbitration schemes at each stage is not fair to all packets. The average latencies for packets are high where fair arbitration is applied at each arbiter. The fair arbitration schemes may therefore lead to sub-optimal utilization of the bus, and do not permit the application of quality of service (QoS) to packets using the bus. However, any solutions to apply QoS to the bus interconnect must provide priority propagation that is low cost and as simple as possible.

### SUMMARY

Aspects disclosed herein provide quality of service (QoS) in bus interconnects with multi-level and/or multi-stage arbitration by tagging packets with an indication of priority. In at least one aspect, the indication of priority is based at least in part on a distance from packet source to packet destination.

In one aspect, an integrated circuit comprises a first arbiter for controlling access to a bus interconnect. The first arbiter is configured to receive a first packet having a first priority at a first input port, and receive a second packet having a second priority, wherein the first and second priorities are based on a distance to a respective destination of the first and second packets. The first arbiter is further configured to forward the first packet upon determining that the first priority is of a higher relative priority than the second priority.

In another aspect, a method comprises receiving a first packet having a first priority at a first arbiter configured to control access to a bus interconnect. The method further comprises receiving, by the first arbiter, a second packet having a second priority, wherein the first and second priorities are based on a distance to a respective destination of the first and second packets. The method further comprises forwarding, by the first arbiter, the first packet upon determining that the first priority is of a higher relative priority than the second priority.

In another aspect, an apparatus comprises means for receiving a first packet having a first priority. The apparatus further comprises means for receiving a second packet having a second priority, wherein the first and second priorities are based on a distance to a respective destination of the first and second packets. The apparatus may further comprise means for forwarding the first packet upon determining that the first priority is of a higher relative priority than the second priority.

In another aspect, an apparatus comprises a first computing element configured to generate a first packet specifying the first computing element as a source and a second computing element as a destination. The apparatus further comprises a first interface coupled to the first computing element. The interface may be configured to identify, in a routing table of the first interface, a priority for the first packet, wherein the priority is based on a distance from the first computing element to the second computing element, and insert an indication of the priority in the first packet.

In another aspect, a method comprises generating, by a first computing element, a first packet specifying the first computing element as a source and a second computing element as a destination. The method further comprises identifying, in a routing table of a first interface coupled to the first computing element, a priority for the first packet, wherein the priority is based on a distance from the first computing element to the second computing element. The method further comprises inserting, by the first interface, an indication of the priority in the first packet.

In still another aspect, an apparatus comprises means for generating a first packet specifying a first computing element, of a plurality of computing elements connected via a bus interconnect, as a source and a second computing element of the plurality of computing elements as a destination. The apparatus further comprises means for identifying a priority for the first packet, wherein the priority is based on a distance from the first computing element to the second computing element. The apparatus further comprises means for inserting an indication of the priority in the first packet.

By tagging packets with an indication of priority, aspects disclosed herein provide quality of service in bus interconnects. The indication of priority may be determined by source computing elements using lookup tables that are based on distances to destination computing elements. Doing so provides low cost propagation of priority in the bus interconnect. Arbiters in the bus interconnect may serve packets having indications of higher priority before serving packets having lower indications of priority. Doing so may provide more efficient utilization of the bus interconnect.

### BRIEF DESCRIPTION OF THE SEVERAL VIEWS OF THE DRAWINGS

So that the manner in which the above recited aspects are attained and can be understood in detail, a more particular description of aspects of the disclosure, briefly summarized above, may be had by reference to the appended drawings.

It is to be noted, however, that the appended drawings illustrate only aspects of this disclosure and are therefore not to be considered limiting of its scope, for the disclosure may admit to other aspects.

FIGS. 1A-1B illustrates an apparatus that implements quality of service in interconnects with multi-stage arbitration, according to one aspect, according to one aspect.

FIGS. 2A-2C illustrate logical views of components configured to provide quality of service in interconnects with multi-stage arbitration, according to one aspect.

FIG. 3 is a flow chart illustrating a method to provide quality of service in interconnects with multi-stage arbitration, according to one aspect.

FIG. 4 is a flow chart illustrating a method to build priority class-based lookup tables, according to one aspect.

FIG. 5 is a flow chart illustrating a method to build credit-based lookup tables, according to one aspect.

FIG. 6 is a flow chart illustrating a method to configure arbiters to perform arbitration operations based on indications of priority stored in packets, according to one aspect.

FIG. 7 is a flow chart illustrating a method to process bus transactions, according to one aspect.

FIG. 8 is a block diagram illustrating a computing device integrating an interconnect configured to provide quality of service, according to one aspect.

### DETAILED DESCRIPTION

Aspects disclosed herein provide quality of service in bus interconnects that perform multi-stage arbitration by tagging packets with an indication of priority that is based on a distance to the destination of each packet. A plurality of source computing elements are communicably coupled by the bus interconnect. Arbiters regulating access to the bus interconnect may use the indication of priority to serve packets having a higher relative priority before serving packets that have a lower relative priority. Generally, aspects disclosed herein provide at least two schemes for tagging packet with an indication of priority, namely priority classes and credits.

Under the priority class scheme, two or more priority classes may be defined. The priority classes may be based on the distance from a source computing element to a destination computing element in an integrated circuit, such as a system on a chip (SoC). As used herein, a “computing element” refers to any hardware structure that is connected to a bus. Examples of computing elements include, without limitation, processors (CPUs), memory, caches, peripherals, network interfaces, and the like. The distance between computing elements may be determined based at least one of: the number of arbiters along the path between the source and destination, and a number of cycles required for the packet to travel from the source to destination. Each interface connecting a given computing element to the bus may include lookup tables (also referred to as routing tables) that specify priority classes for each destination computing element. In at least one aspect, the priority class assigned to a packet is static, in that the packet retains the same priority class from source to destination.

Therefore, when a source computing element generates a first packet under the priority class scheme, the interface connecting the source to the bus interconnect may reference the lookup tables to determine a priority class for the first packet based on the packet's destination (a computing element). The interface may then insert an indication of the priority classes in the first packet. A first arbiter controlling access to the bus interconnect may receive the first packet specifying the first priority class at a first input port, and a second input packet specifying a second priority class at a second input port. The first and second priority classes are based on a distance to a respective destination of the first and second packets, respectively. The first arbiter may compare the first and second priority classes, and forward the first packet based on a determination that the first priority class is of a higher relative priority than the second priority class.

Under the credit-based scheme, the source interfaces tag packets with an indication of a number of credits. The number of credits may be based on a function of one or more of a distance from the source computing element to the destination computing element, a bandwidth of the bus interconnect, and a latency of the bus interconnect. In at least one aspect, the source interfaces store lookup tables that specify the number of credits that should be given to a packet based on the packet's destination. When receiving a packet from a source computing element, the source interface may reference the lookup table to determine how many credits the packet should receive. The source interface may then insert an indication of the number of credits into the packet. Each credit-based arbiter along the bus interconnect serves packets with higher numbers of credits before serving packets with lower numbers of credits. When serving a packet, the credit-based arbiters may decrement the number of credits of the packet, and in some aspects by a predefined number (that may be specific to an arbiter). Once decremented, an indication of the updated number of credits may then be stored in the packet.

Therefore, when a source computing element generates a first packet under the credit-based scheme, the source interface may reference the lookup tables to determine a number of credits for the first packet based on the packet's destination computing element. The source interface may then insert an indication of the number of credits in the first packet. A first arbiter controlling access to the bus interconnect may receive the first packet at a first input port, and a second input packet specifying a second number of credits at a second input port. The first and second numbers of credits are based on a distance to a respective destination of the first and second packets, respectively. The first arbiter may compare the first and second numbers of credits, and forward the first packet based on a determination that the first number of credits is of a higher relative priority than the second number of credits.

In addition, aspects disclosed herein provide different lookup tables for each phase of a bus transaction. For example, if a bus transaction includes a request phase, data phase, snoop phase, and a response phase, the source interfaces may include a lookup table for each phase of the transaction. The source interfaces may then reference the lookup table corresponding to the current phase of the bus transaction, and tag the packet with an indication of priority (e.g., credits or priority class).

In addition, aspects disclosed herein may assign separate indications of priority per dimension traveled from source to destination. Generally, modern bus interconnects are built in many dimensions. For example, a three-dimensional bus interconnect may be considered to have an x-dimension, a y-dimension, and a z-dimension. In such an example, a packet may be tagged with an indication of priority for each of the three dimensions, where each indication of priority is based on the distance (in each respective dimension) from the packet source to the packet destination. Therefore, the priority for the x-dimension would be based on the distance to the destination in the x-dimension, while the priority for the y-dimension would be based on the distance to the destination in the y-dimension, and the priority for the z-dimension would be based on the distance to the destination in the z-dimension. The source interfaces may therefore include lookup tables that specify priority classes and/or credits for each dimension in the bus interconnect.

Further still, aspects disclosed herein may provide the ability to map between the credit-based and priority class-based schemes. For example, a router (that includes multiple arbiters) may receive a packet that specifies a number of credits. The router may include logic to convert the number of credits to a priority class, such that a priority-class based arbiter in the router can serve the packet based on the converted priority class. Similarly, the router may include logic to convert a priority class to a number of credits.

Aspects of the disclosure are equally applicable to multiple types of bus interconnects, including all ring bus structures, mesh interconnects, and network on chip (NoC) interconnects. The use of any particular bus type herein as a reference example should not be considered limiting of the disclosure.

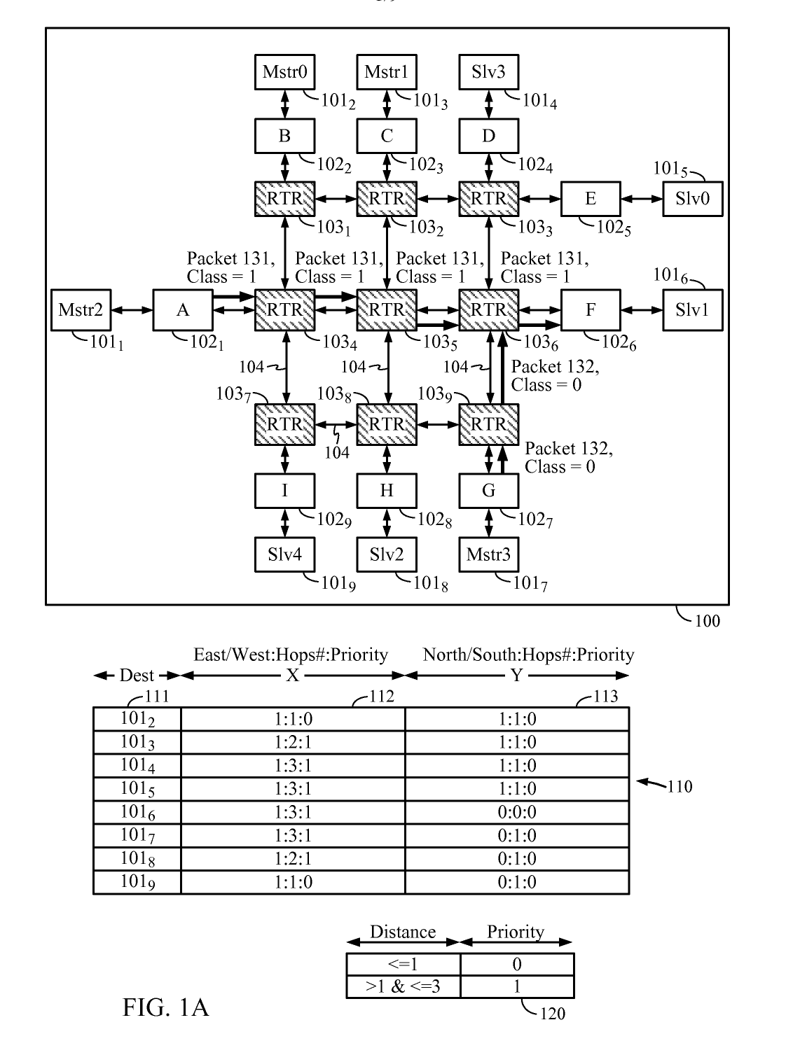

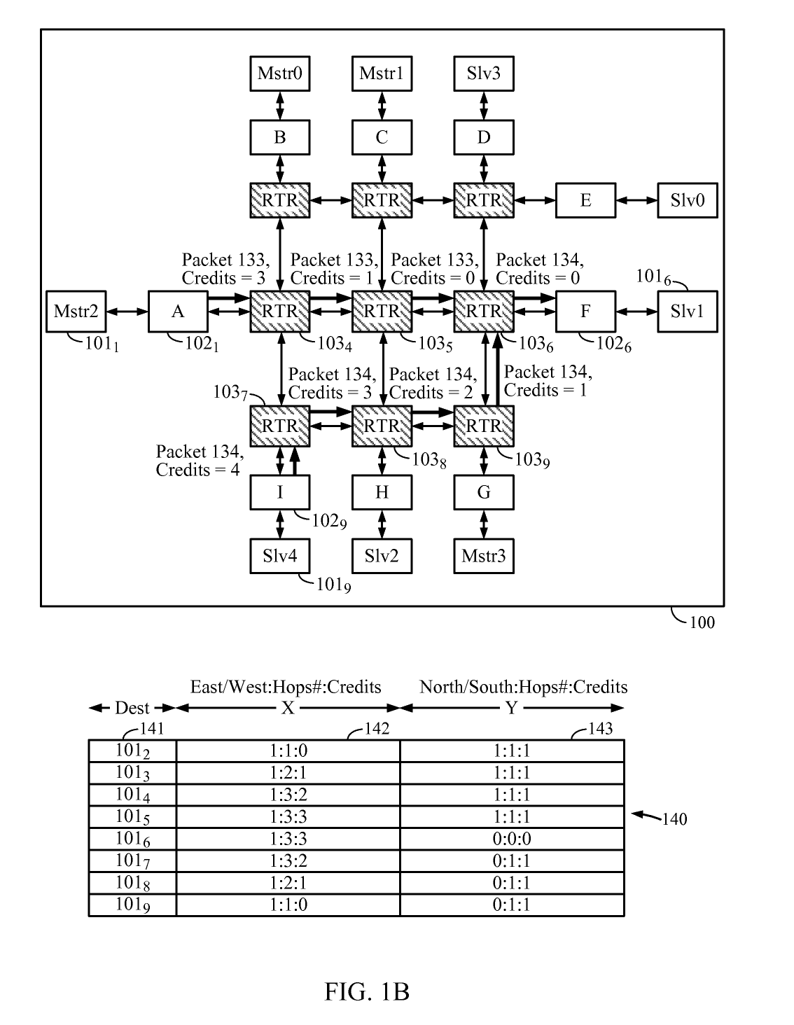

FIG. 1A illustrates an apparatus that implements quality of service in interconnects with multi-stage arbitration, according to one aspect. FIG. 1A depicts a logical view of components of an integrated circuit 100. In at least some aspects, the integrated circuit may 100 may be a system on a chip (SoC). As shown, the integrated circuit 100 includes a plurality of computing elements 101₁₋₉ configured to generate and/or forward packets for bus transactions. The computing elements 101 may be any type of computing element, such as a processor, network interfaces, memory, cache, digital signal processor (DSP), and the like. Logic for generating and forwarding data packets may be implemented using hardware, software, firmware, or any combination thereof. The computing elements 101 are communicably coupled via a bus 104. Each segment of the bus 104 is not marked for the sake of clarity. The bus 104, as shown, is a two-dimensional bus, in that packets may travel the bus 104 in two different dimensions. However, the bus 104 may be of any number of dimensions. The bus 104 is a multi-stage bus in that a plurality of routers 103₁₋₉ are configured to control access to a segment of the bus 104 by the computing elements 101₁₋₉. Generally, each router 103 includes one or more arbiters (not pictured) that perform arbitration operations to control access to the segments of the bus 104 by packets generated by the computing elements 101₁₋₉.

As shown, the computing elements 101₁₋₉ are connected to the bus 104 via a respective source interface 102₁₋₉. Each source interface 102₁₋₉ includes logic (not pictured) configured to tag packets generated (or forwarded) by the computing elements 101₁₋₉ with an indication of priority. Examples of source interfaces include bridges, where the bridge connects a given computing element 101₁₋₉ to the bus 104. Each source interface 102₁₋₉ may insert an indication of priority in packets based on priority information stored in one or more lookup tables of the source interface 102₁₋₉. The indication of priority (e.g., a priority class or number of credits) may be inserted using hardware, software, firmware, or any combination thereof. Generally, the priority information stored in the lookup tables is based on a distance from the corresponding source computing element 101₁₋₉ to a respective destination computing element 101₁₋₉.

FIG. 1A further depicts an example of a lookup table 110. The lookup table 110 is an example of a priority-class based lookup table, in that each entry of the lookup table 110 specifies a priority class of at least two different predefined priority classes. Table 120, as shown, provides example priority classes based on a distance from a source computing element 101₁₋₉ to a destination computing element 101₁₋₉. In at least one aspect, the distance may be based on one or more of a number of routers 103₁₋₉ (or arbiters, where one arbiter is considered per router 103₁₋₉) along the path from a source computing element 101₁₋₉ to a destination computing element 101₁₋₉. In other aspects, the distance may be based on a number of cycles required for a packet to travel from a source computing element 101₁₋₉ to a destination computing element 101₁₋₉.

As shown, table 120 defines two example priority classes that are based on a number of arbiters (or routers 103) disposed between a source computing element 101₁₋₉ and a destination computing element 101₁₋₉. However, any number of priority classes may be defined. Similarly, the priority classes may be based on an absolute value (e.g., 1 arbiter) or range of values (e.g., 0-2 arbiters). As shown, the table 120 reflects a priority class indication of “0” where one or fewer routers 103₁₋₉ are disposed on a path between the source computing element 101₁₋₉ and a destination computing element 101₁₋₉. Similarly, the table 120 reflects a priority class indication of “1” where more than one, but less than or equal to three routers 103 are disposed between the source computing element 101₁₋₉ and a destination computing element 101₁₋₉. In at least one aspect, since priority class 1 is associated with a greater distance between computing elements 101 than priority class 0, an arbiter in the routers 103 may serve packets tagged with priority class 1 before serving packets tagged with priority class 0, as priority class 1 is of a higher relative priority than priority class 0.

The example lookup table 110 includes values that are computed based on the topology of the integrated circuit 100 from the perspective of computing element 101₁. Therefore, the lookup table 110 may be stored in the source interface 102₁. However, in some aspects, the lookup table may be stored in the computing elements 101, which may include logic implemented by the interfaces 102 to tag packets with an indication of priority, such as a priority class or number of credits. As shown, the lookup table 110 includes a destination column 111, a column 112 for the x-dimension of the bus 104 (or east/west direction), and a column 113 for the y-dimension of the bus 104 (or the north/south direction). The destination column 111 specifies a computing element 101 that is a destination of packets sent by the computing element 101₁. The columns 112 and 113 define values used by the interface 102 to tag packets generated (or forwarded) by the computing element 101₁ with an appropriate priority class that is based on the distance to the respective destination computing element 101₂₋₉. The values in the columns 112, 113 are shown with an example format that corresponds to “direction:distance:priority class”. However, the columns 112, 113 may take any format suitable to specify at least an indication of priority for a packet (such as a priority class or number of credits). The “direction” component may be a binary value that indicates whether to forward the packet via an east or west port of the interface 102₁ (similarly, when added to a packet, this value may be used by the routers 103 to forward packets in the appropriate direction). The “distance” component may specify the distance (measured in number of routers 103) from the source computing element 101₁ to a destination computing element 101₂₋₉. The “priority” component specifies one of the two priority classes defined in the table 120.

Therefore, as shown, column 112 for destination 101₃ specifies an example entry of “1:2:1”. The entry indicates that the interface 102₁, when identifying a packet generated (or forwarded) by source 101₁, should forward the packet through the east port of the interface 102₁, that two routers/arbiters in the x-dimension are disposed between source 101₁ and destination 101₃ (for example, routers 103₄ and 103₅), and the packet should be tagged with priority class 1 as an indication of priority in the x-dimension. Similarly, as shown, the entry in column 113 for destination 101₃ is “1:1:0”. This entry reflects that computing element 101₃ is north of computing element 101₁, that one router/arbiter in the y-dimension is disposed between source 101₁ and destination 101₃ (for example, router 103₂), and the packet should be tagged with priority class 0 as an indication of priority in the y-dimension based on the number of routers 103 in the y-dimension between the source 101₁ and destination 101₃. Therefore, as shown, a given packet may have different priorities for the x-dimension and the y-dimension of the bus 104.

FIG. 1A further depicts routes traversed by two example packets 131 and 132. As shown, packet 131 originates from computing element 101₁, while packet 132 originates from computing element 101₇. For the purpose of this example, both packets specify the same destination, namely computing element 101₆. By referencing the routing table 110, interface 102₁ may tag packet 131 with a priority class of 1 (in the x-dimension) based on the destination of computing element 101₇. Similarly, interface 102₇ may reference its own version of the routing table 110 (which is generated based on the bus topology from the perspective of computing element 101₇), and tag packet 132 with a priority class of 0 in the x-dimension (as no routers 103 are disposed in the x-dimension between computing elements 101₇ and 101₆). As shown, the packets 131, 132 retain a static priority from source to destination.

As each router 103 receives a packet 131, 132, the arbiters of the router 103 perform arbitration operations to allow one packet to access the bus 104 per cycle. The arbiters may compare priority classes in the packets to determine which packet to serve first. For example, assuming packets 131, 132 are in different input queues of an arbiter in router 103₆, the arbiter may compare the priority classes specified in the packets 131, 132. The arbiter may then determine that packet 131, specifying a priority class of 1, has a higher relative priority than packet 132, which specifies a priority class of 0. As shown, therefore, the arbiter of router 103₆ serves packet 131 before packet 132, forwarding packet 131 to interface 102₆ (and subsequently to the destination computing element 101₆). Packet 132 may be subject to one or more additional arbitration operations before the router 103₆ forwards the packet 132 to its destination.

FIG. 1B illustrates an aspect where the integrated circuit 100 of FIG. 1A implements a credit-based arbitration scheme. To implement the credit-based arbitration scheme, the interfaces 102₁₋₉ (or the computing elements 101₁₋₉) include logic configured to insert an indication of a number of credits in packets. The number of credits may be based on a function that considers one or more of: (i) the distance from the source computing element 101₁₋₉ to a destination computing element 101₁₋₉, (ii) a bandwidth of the bus 104, and (iii) a latency of the bus 104. The interfaces 102₁₋₉ (and/or the computing elements 101₁₋₉) include a lookup table that specifies a number of credits that should be assigned to a packet that targets a specific destination computing element 101₁₋₉. As shown, the table 140 reflects a credit-based lookup table that is defined from the perspective of computing element 101₁. The lookup table 140 includes a column 141 for a destination computing element 101₂₋₉, a column 142 specifying credits in the x-dimension, and a column 143 specifying credits in the y-dimension. The format of columns 142, 143 is an example format of “direction:distance:credits”. The “direction” component of columns 142, 143, corresponds to the “direction” components of columns 112, 113. Similarly, the “distance” component corresponds to a distance between the source computing element 101₁ and the destination computing element 101₁₋₉. The distance may be based on a number of routers 103 (or arbiters) between the source and destination, or a number of cycles required for a packet to travel from the source to the destination. The “credits” component of columns 142, 143 specify a number of credits for the respective destination computing element 101₂₋₉ targeted by a packet generated or forwarded by computing element 101₁. As with lookup table 110, lookup table 140 is exemplary, and the particular values and/or formatting therein should not be considered limiting of the disclosure. Generally, the lookup tables 110, 140 may take any format sufficient to specify an indication of priority (in this example, a number of credits) for packets targeting a given destination computing element 101₁₋₉.

As shown, for example, lookup table 140 provides packets targeting computing element 101₉ with 0 credits in the x-dimension and 1 credit in the y-dimension. Therefore, when source interface 102₁ receives a packet specifying computing element 101₁ as the source and specifying computing element 101₉ as a destination, logic in the source interface 102₁ may reference the table 140 using computing element 101₉ as an index value. The logic may determine that the entry for computing element 101₉ provides 0 credits in the x-dimension, and 1 credit in the y-dimension. Therefore, the logic in the source interface 102₁ may insert, in the packet, an indication of 0 credits in the x-dimension and an indication of 1 credit in the y-dimension. In at least one aspect, the logic in the source interface 102₁ may sum the credits in the x-dimension and y-dimension and insert an indication of the summed number of credits in the packet. Logic in the source interface 102₁ may then forward the packet onto the bus 104.

To implement the credit-based scheme, the arbiters of the routers 103 include logic configured to perform arbitration operations based on the number of credits specified in each packet. The arbiters may compare the numbers of credits of each packet in the input queues of the arbiter, and serve the packet having the highest number of credits (e.g., by forwarding the packet via an output port of the arbiter). The arbiters (or the routers 103) may include logic (not pictured) to decrement the credits of the packets by a predefined number of credits as packets are served. The predefined number of credits may be specific to each arbiter/router, and may be based on the complexity of the arbiter/router. For example, router 103₄ may decrement 2 credits, router 103₅ may decrement 1 credit. Before forwarding the packet via an output port of the arbiter, the logic may update the number of credits in the packet to reflect the number of credits that were decremented.

FIG. 1B illustrates two example packets, namely packet 133 generated by computing element 101₁ and targeting computing element 101₆ as a destination, and packet 134 generated by computing element 101₉ and also targeting computing element 101₆ as a destination. As shown, packet 133 is initially tagged by source interface 102₁ with an indication that the packet has 3 credits (which may be specified in a lookup table 140 stored in the source interface 102₁). For the sake of clarity, the example depicted in FIG. 1B reflects an aspect where a single indication of credits is specified in the packets 133, 134, namely the sum of the credits in the x-dimension and the y-dimension specified in the table 140. However, as previously indicated, the packets 133, 134 may specify separate indications of credits for each dimension. As shown, when router 103₄ forwards packet 133, two credits are decremented, leaving packet 133 with one remaining credit. When router 103₅ forwards packet 133 on the bus 104, one credit is decremented, leaving packet 133 with zero remaining credits. As shown, source interface 102₉ initially tags packet 134 with 4 credits (which may be specified in a lookup table 140 specific to source 101₉ and stored in source interface 102₉). As shown, routers 103₇, 103₈, and 103₉ each decrement one credit when packet 134 is served. Therefore, when packet 134 arrives at router 103₆, packet 134 specifies an indication of 1 credit. When packets 133 and 134 are in input ports of an arbiter in router 103₆, the arbiter will compare the number of credits in each packet to determine which packet has a higher relative priority. As shown, since packet 134 has 1 credit, greater than the zero credits specified in packet 133, the arbiter in router 103₆ will forward packet 134 before forwarding packet 133.

In at least one aspect, the routers 103₁₋₉ may include both credit-based and priority class-based arbiters. Further still, some routers 103₁₋₉ may include only credit-based arbiters, while other routers 103₁₋₉ include only priority-class based arbiters. To support such hybrid deployments, the routers 103₁₋₉ may include logic to convert credits to priority classes, and convert priority classes to credits.

Further still, the lookup tables 110, 140 may be specific to one or more phases (of multiple phases) of a bus transaction. The source interfaces 102₁₋₉ (and/or the computing elements 101₁₋₉) may therefore have a lookup table for each phase of a bus transaction. For example, a bus transaction may have, without limitation, a command phase, a data phase, a response phase, and a snoop phase. Therefore, in such aspects, the source interfaces 102₁₋₉ may have a command phase lookup table, a data phase lookup table, a response phase lookup table, and a snoop phase lookup table. Additionally, a given lookup table may provide different schemes for different dimensions. For example, lookup table 110 may specify credits for the x-dimension, and priority classes for the y-dimension.

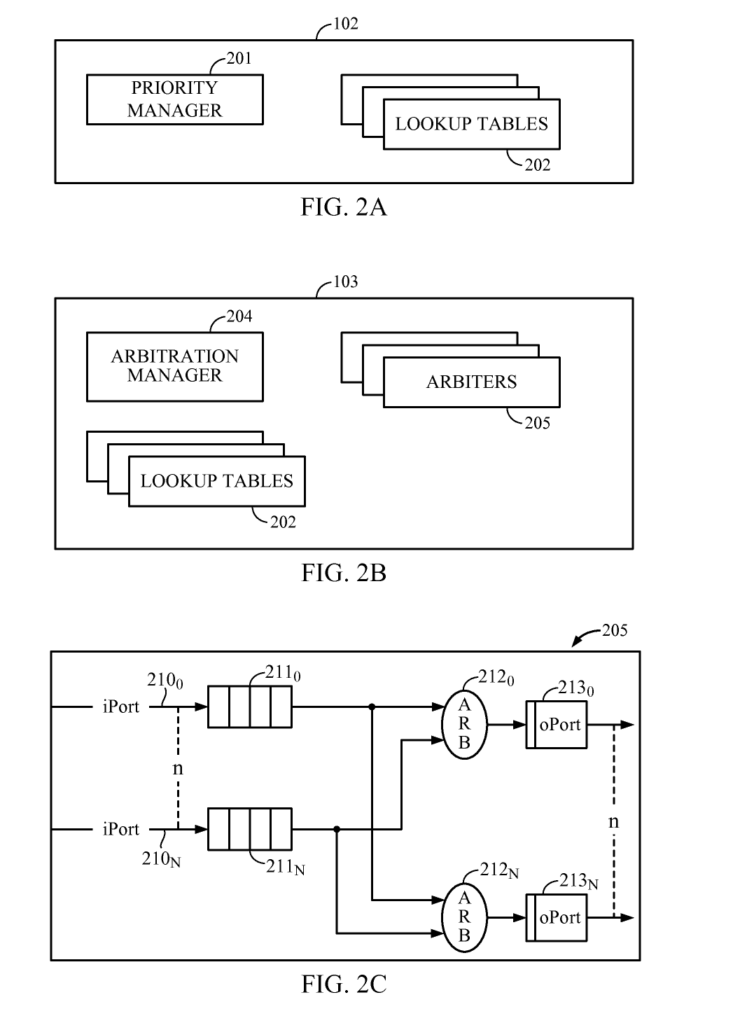

FIG. 2A illustrates a logical view of a source interface 102 of the integrated circuit 100, according to one aspect. As previously indicated, the source interface 102 connects a computing element 101 to the bus 104. As shown, the source interface 102 includes a priority manager 201 and lookup tables 202. The lookup tables 202 may specify indications of priority that are based at least in part on distances from the computing element 101 connected to the bus 104 via the source interface 102 to a different computing element 101 of the integrated circuit 100. The lookup tables 202 may specify credits, priority classes, or any combination thereof. Generally, the indications of priority may be any number of bits in length. As previously described with reference to FIGS. 1A-1B, the lookup tables 202 may be specific to a particular phase of a bus transaction. Additionally, the lookup tables 202 may specify indications of priority for each dimension in the bus interconnect.

The priority manager 201 is logic configured to insert an indication of priority into packets generated (or forwarded) by a computing element 101. The indications of priority may be based on predefined formatting, and inserted in predefined locations in each packet. When a source computing element 101 attempts to transmit a packet via the bus 104 as part of a phase of the bus transaction, the priority manager 201 in the source interface 102 may reference the lookup table 202 corresponding to the phase of the bus transaction. The priority manager 201 may use a destination of the packet as an index into the appropriate lookup table 202. The priority manager 201 may then determine the number of credits and/or the priority class associated with the destination, and insert an indication of the number of credits and/or the priority class in the packet. The priority manager 201 may then forward the packet for arbitration in multiple stages by the arbiters 205. The priority manager 201 may be implemented using hardware, software, firmware, or any combination thereof.

FIG. 2B is a logical view of components of a router 103. As shown, the router 103 includes an arbitration manager 204, one or more arbiters 205, and one or more lookup tables 202. The arbitration manager 204 is logic that is configured to facilitate routing of packets received by the router 103. The arbitration manager 204 may be implemented using hardware, software, firmware, or any combination thereof. The arbitration manager 204 may further provide logic configured to convert indications of priority classes in packets to indications of credits. Similarly, the arbitration manager 204 may provide logic configured to convert indications of credits in packets to indications of a priority class. The arbitration manager 204 may further include logic configured to insert the converted indications into the packets. Further still, the arbitration manager 204 may include logic configured to compute updated priority classes or numbers of credits for packets. For example, a router 103 may receive a packet that has zero credits remaining, yet has not reached its destination. The arbitration manager 204 may compute more credits for the packet, and insert an indication of the computed credits in the packet before forwarding the packet. In at least one aspect, arbitration managers 204 in different routers 103 need not apply identical algorithms when computing updated priority classes or numbers of credits for packets. For example, one arbitration manager 204 in a first router 103 may apply an algorithm that computes a different number of credits or priority class than an algorithm applied by a second arbitration manager 204 in a second router 103. The arbitration manager 204 may further include logic configured to route packets to their destination via the bus 104 by routing the packets via an appropriate output port (which may be controlled by one or more arbiters 205). In at least one aspect, the arbitration manager 204 may determine the appropriate output port via an indication of direction in the packets (such as the north/south or east/west indications depicted in the lookup tables 110, 140). In another aspect, the arbitration manager 204 of the routers 103 may reference routing information stored in the lookup tables 202 to determine the appropriate output port for a packet.

The arbiters 205 are devices configured to control access to a shared resource, such as the bus 104. In some aspects, the arbiters 205 include priority arbiters that provide quality of service (QoS) by serving packets based on indications of priority stored in the packets, such as credits or priority classes. The routers 103 may include arbiters 205 that are configured to arbitrate based on priority class and arbiters 205 that are configured to arbitrate based on credits. The arbiters 205 may include logic (hardware, software, or firmware) that can determine whether to update the number of credits in a packet (or the priority class of a packet) that is served by an arbiter 205. Examples of such logic include incrementing logic and decrementing logic. Similarly, the arbiter 205 may include logic that does not modify the priority class or number of credits of a packet. In at least one aspect, such logic is included in the arbitration manager 204 of the routers 103.

FIG. 2C depicts a more detailed view of an arbiter 205. As shown, the arbiter 205 includes one or more input ports 210_{0-N}. When packets are received at an input port 210, the packets are placed in a corresponding input queue 211_{0-N}. Arbitration logic 212_{0-N} then grants the packets in the input queues 211_{0-N} access to the output ports 213_{0-N} based on indications of priority stored in the packets. The arbitration logic 212_{0-N} is configured to grant packets having higher relative priorities first. For example, the arbitration logic 212_{0-N} may compare priority class values stored in packets, and serve the packet having the highest priority class. For example, if packet x in input port 210₀ specifies a priority class of 1, while packet y in input port 210_{N} specifies a priority class of 0, the arbitration logic 212_{0-N} may grant packet x access to the corresponding output port 213_{0-N} before granting packet y access to the output port 213_{0-N} based on a comparison of the priority class values (where higher priority class values indicate higher relative priorities). The arbiter 205 may be a priority arbiter in that the arbiter 205 has an input queue 211 for each level of priority (e.g., a priority class, or a number of credits). In such aspects, the arbitration logic 212_{0-N} is configured to ensure that the packets in the higher priority queues are served before lower priority packets. In the event of a tie (e.g., priority class values are equal), the arbitration logic 212_{0-N} performs fair arbitration. In at least one aspect, the arbitration logic 212_{0-N} includes at least a portion of the arbitration manager 204.

Similarly, the arbitration logic 212_{0-N} may compare numbers of credits stored in packets, and serve the packet having the greatest number of credits. For example, if packet x in input port 210₀ specifies an indication of 1 credit, while packet y in input port 210_{N} specifies an indication of 2 credits, the arbitration logic 212_{0-N} may grant packet y access to the corresponding output port 213_{0-N} before granting packet x access to the output port 213_{0-N} based on a comparison of the credits (where greater numbers of credits indicate higher relative priorities). In the event of a tie (e.g., the numbers of credits are equal), the arbitration logic 212_{0-N} performs fair arbitration.

When granted access to an output port 213_{0-N}, a packet may then traverse the bus 104 for another stage of arbitration by arbiters 205 in a different router 103, or the packet may arrive at a destination computing element 101.

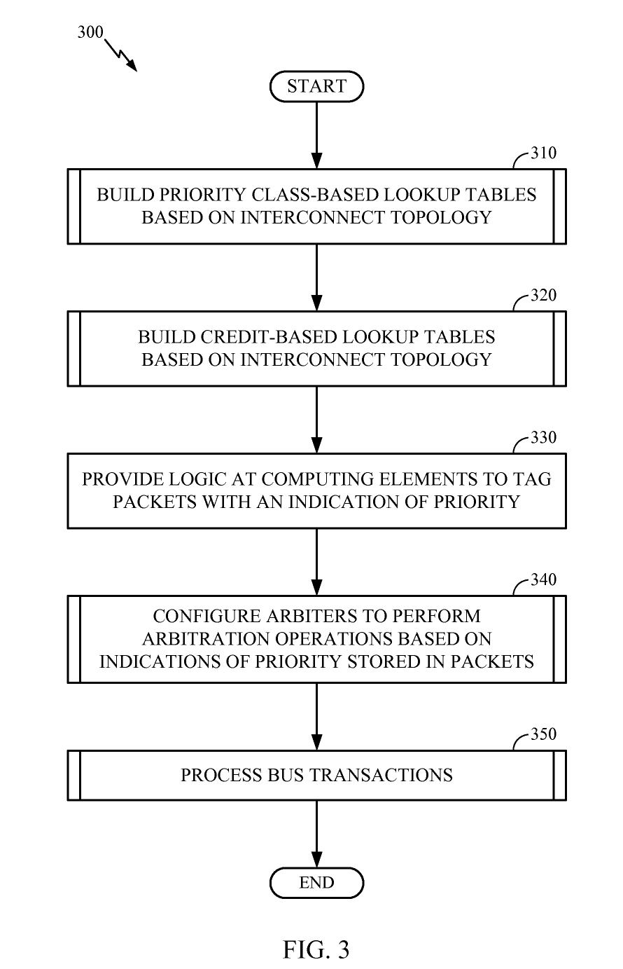

FIG. 3 is a flow chart illustrating a method 300 to provide quality of service in interconnects with multi-stage arbitration, according to one aspect. Generally, the steps of the method 300 provide source interfaces (or computing elements) in an integrated circuit, such as a system on a chip (SoC), that tag packets with an indication of priority based at least in part on a distance to a destination computing element. The indication of priority may be a priority class or number of credits. The computing elements may be connected by a bus interconnect, such as a ring bus, mesh interconnect, or network on a chip (NoC) interconnect. Arbiters in one or more routers may control access to a portion of the bus for a bus cycle. The arbiters may be priority arbiters that serve packets having higher indications of relative priority before serving packets with lower indications of relative priority. For example, the arbiters would serve a packet having 6 credits before serving a packet having 5 credits.

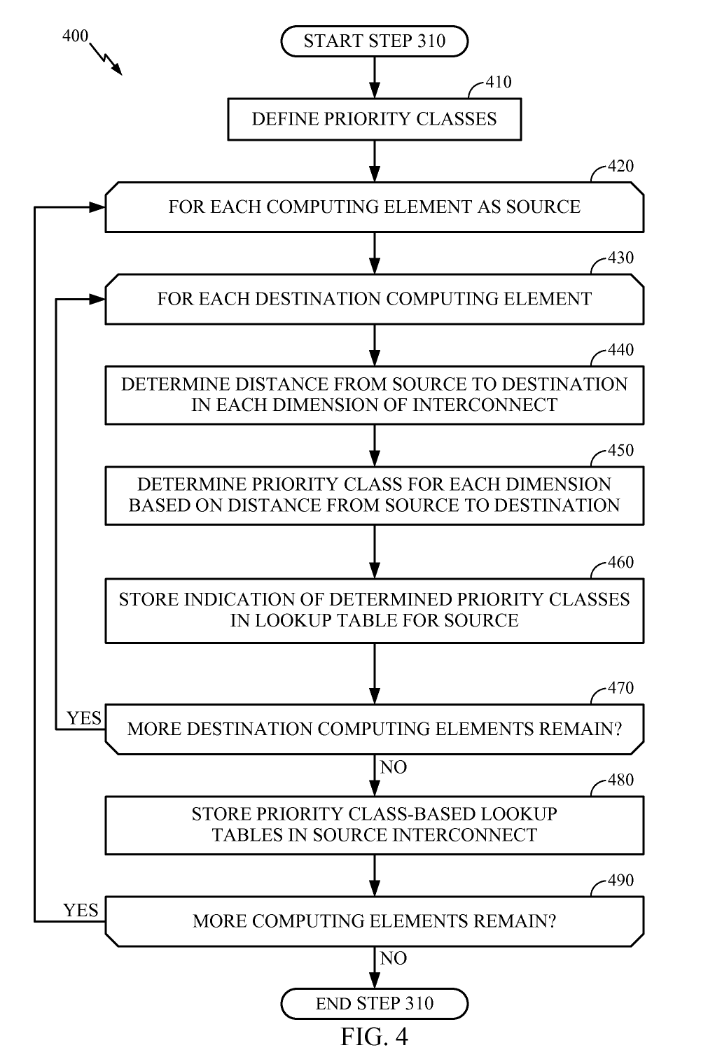

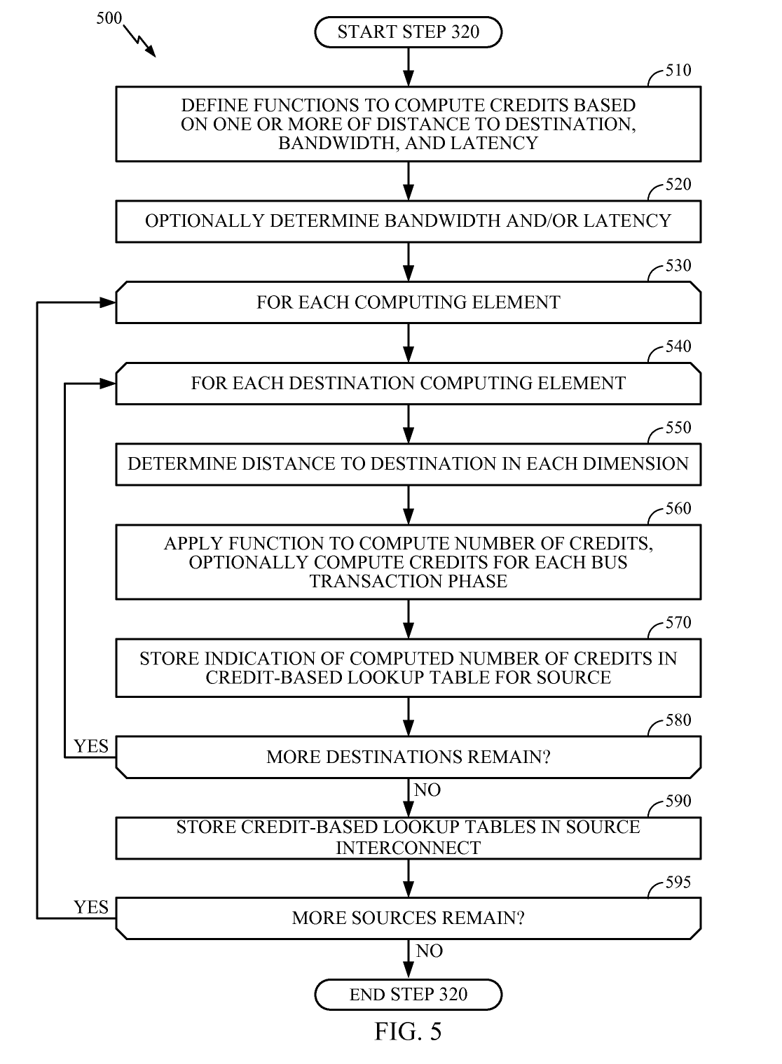

As shown, the method 300 begins at step 310, described in greater detail with reference to FIG. 4, where priority class-based lookup tables are built based on the topology of the bus interconnect. In one aspect, the priority class-based lookup tables may be stored in source interfaces (such as the interfaces 102) that connect the computing elements to the bus interconnect. In another aspect, the priority class-based lookup tables may be stored in the computing element itself. Doing so provides ways to tag packets with an indication of a priority class that is based on a distance to the packet's destination computing element. At step 320, described in greater detail with reference to FIG. 5, credit-based lookup tables are built based on the topology of the bus interconnect. In one aspect, the credit-based lookup tables may be stored in source interfaces (such as the interfaces 102) that connect the computing elements to the bus interconnect. In another aspect, the credit-based lookup tables may be stored in the computing element itself. Doing so provides means to tag packets with an indication of a number of credits that is based on a distance to the packet's destination computing element.

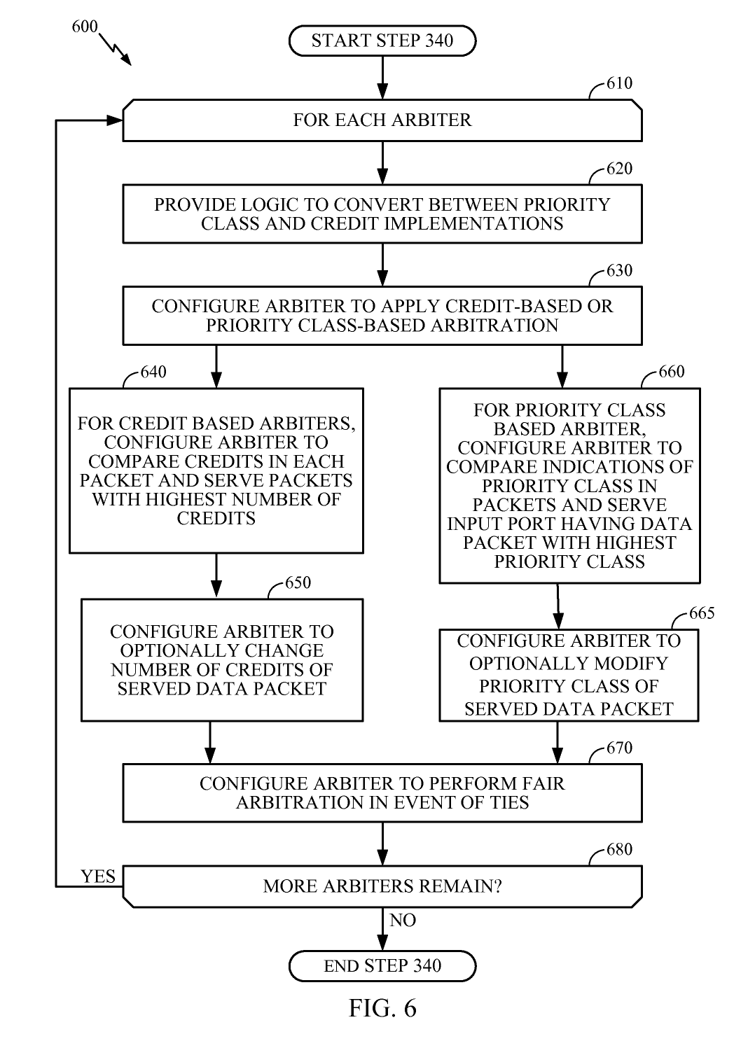

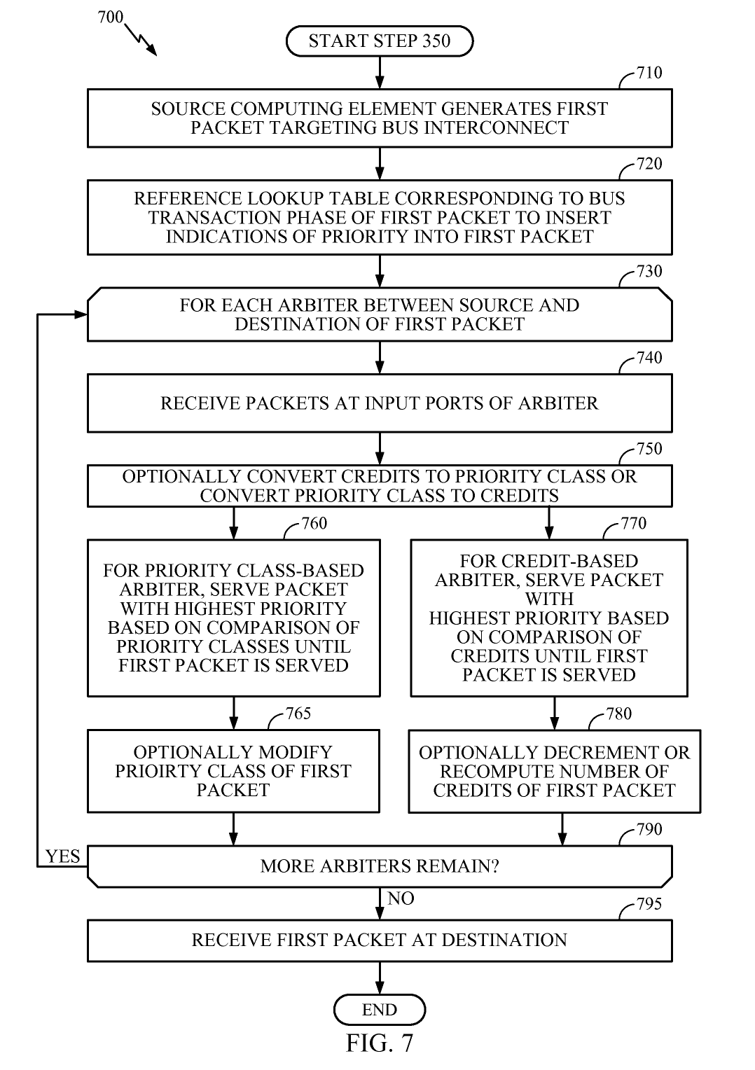

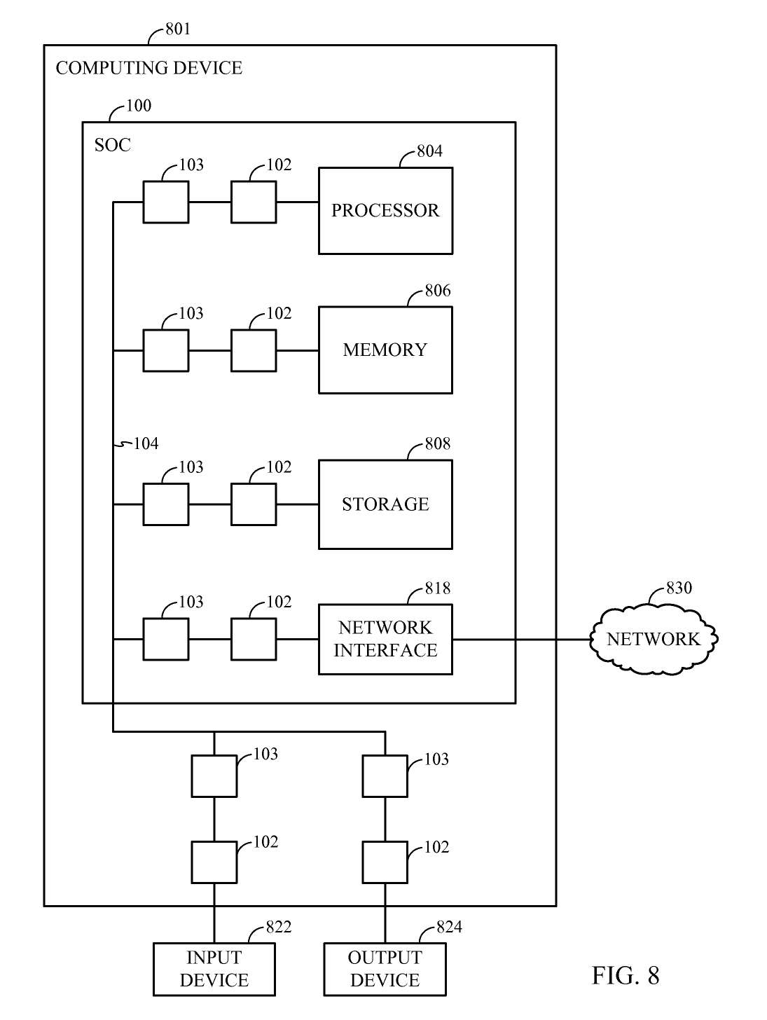

At step 330, logic is provided at the source interfaces to tag packets with a k-bit indication of priority. The logic is configured to determine the k-bit priority by referencing the lookup tables using a destination of the packet as an index. The logic may then insert the corresponding k-bit priority in the packet. The k-bit indication of priority may correspond to a priority class and/or a number of credits. At step 340, described in greater detail with reference to FIG. 6, arbiters controlling access to the bus interconnect are configured to perform arbitration operations based on comparisons of the k-bit indications of priority in the packet. For example, credit based arbiters may compare numbers of credits in two or more packets, and grant the packet having the highest number of credits access to an output port (and correspondingly, access to the bus). Similarly, priority-class based arbiters may compare k-bit indications of priority classes in packets two or more packets, and grant the packet having the highest priority class to the output port. At step 350, described in greater detail with reference to FIG. 7, bus transactions may be processed on the integrated circuit. For example, a computing element such as a processor may request data stored in higher level memory, which is completed in a series of bus transaction phases.

FIG. 4 is a flow chart illustrating a method 400 corresponding to step 310 to build priority class-based lookup tables, according to one aspect. Generally, the steps of the method 400 describe techniques to generate lookup tables for each computing element in an integrated circuit (such as an SoC) that specify priority classes for packets targeting other computing elements in the integrated circuit. For example, an engineer may perform the steps of the method 400 to manually create distance-based priority class lookup tables when designing the integrated circuit. Similarly, the engineer may design computer programs to automate the steps of the method 400 to create the priority class-based lookup tables. Further still, logic or firmware in the integrated circuit implementing the steps of the method 400 may automatically build the priority class-based lookup tables. The priority classes are based on a distance between the computing elements, where the distance is measured based on a number of arbiters (or routers) on the path between the computing elements and/or the number of bus cycles required for packets to travel from the source to the destination.

As shown, the method 400 begins at step 410, where at least two priority classes are defined. Example priority classes are depicted in table 120 of FIG. 1A. The priority classes may be based on the measure of distance between computing elements. For example, where the distance is based on a number of arbiters between computing elements, zero to two arbiters may define a first priority class, while three or more arbiters may define a second priority class. Where distance is defined based on a number of cycles for the packet to reach the destination, one to five cycles may define a first priority class, six to ten cycles may define a second priority class, and more than ten cycles may define a third priority class. Generally, the priority classes associated with greater distances (either in terms of number of arbiters or number of cycles) are defined as being of a higher relative priority. In addition, priority classes may be defined for different phases of a bus transaction, where more important phases of the bus transaction are afforded a higher priority. For example, the priority classes for a request phase of a bus transaction may specify zero to two arbiters as being of the second priority class, while three or more arbiters are of a third priority class (and therefore, the first priority class is not assigned to request phase packets).

At step 420, a loop including steps 430-490 is performed to build a priority class-based lookup table for each computing element as a source computing element in the integrated circuit. At step 430, a loop including steps 440-470 is performed for each destination computing element relative to the current computing element as a source. At step 440, the distance from the current source computing element to the current destination computing element is determined. The distance may include distances in each dimension of the bus interconnect, such as an x-dimension, y-dimension, and z-dimension in a three-dimensional interconnect. The distances may be determined based on a number of arbiters between the computing elements and/or a number of cycles required for a packet to travel from the source to the destination.

At step 450, a priority class may be determined for each dimension of the interconnect based on the distance from the source to the destination. For example, continuing with the above priority classes for the request phase (based on number of arbiters), if the distance in the x-dimension is 1 arbiter, the distance in the y-dimension is 2 arbiters, and the distance in the z-dimension is four arbiters, an entry in the lookup table for the current source to the current destination would specify the second priority class (zero to two arbiters) in the x-dimension and the y-dimension, and the third priority class (three or more arbiters) in the z-dimension. When the source computing element subsequently generates a packet targeting the current destination as part of a request phase of a bus transaction, the priority manager 201 (or the source itself) may tag the packet with indications of the priority classes in each dimension. Using the determined distances against the defined priority classes for each phase of the bus transaction, entries for the lookup table for each phase of the bus transaction may be defined.

In some aspects, however, a common priority class may be specified for each dimension based on the total number of arbiters in each dimension. In such aspects, the lookup tables may specify ranges and/or absolute values for the total number of arbiters in all dimensions, and the priority manager 201 may tag packets with an indication of a single priority class.

At step 460, an indication of the priority classes for the current source to the current destination determined at step 450 may be stored in the lookup tables of the interface of the current source computing element. As previously indicated, priority classes for each dimension of the bus interconnect may be computed at step 450. Therefore, in such aspects, the computed priority classes for each dimension may be stored in a lookup table for the respective dimension of the bus interconnect at step 460 (where the interface stores a lookup table for each dimension of the bus interconnect). Step 470 of the method 400 includes a determination as to whether more destination computing elements remain relative to the current source computing element. If more destination computing elements remain, the method returns to step 430. If no more destination computing elements remain, priority classes for each destination computing element relative to the current source computing element have been defined, and the method proceeds to step 480. At step 480, the priority-class based lookup tables may be stored in the source interface 102 (and/or the computing element 101) as lookup tables 202. Step 490 of the method 400 includes a determination of whether more source computing elements in the integrated circuit remain. If more source computing elements remain, the method 400 returns to step 420 to build priority-class based lookup tables for the remaining source computing elements. Otherwise, the method 400 ends.

FIG. 5 is a flow chart illustrating a method 500 corresponding to step 320 to build credit-based lookup tables, according to one aspect. Generally, the steps of the method 500 describe techniques to generate lookup tables for each computing element in an integrated circuit (such as an SoC) that specify numbers of credits for packets targeting other computing elements in the integrated circuit. For example, an engineer may perform the steps of the method 500 manually create credit-based lookup tables. Similarly, the engineer may design computer programs to automate the steps of the method 500 to create the credit-based lookup tables. Further still, logic or firmware in the integrated circuit implementing the steps of the method 500 may automatically build the credit-based lookup tables.

At step 510, a user may define at least one function to compute credits based on one or more of the distance from a source to a destination computing element, bandwidth of the bus interconnect, and latency of the bus interconnect. In at least one aspect, different functions may be defined for each phase of a bus transaction. Doing so may facilitate allocation of more credits to more important phases of the bus transaction, and fewer credits to less important phases of the bus transaction. At step 520, the bandwidth and/or latency of the bus interconnect may optionally be determined. The bandwidth of the bus interconnect may be determined by computing a product of the width of the bus and the speed of the bus. The latency of the bus may be determined based on computer-based simulations, or may be based on historic latency values for similar bus interconnects.

At step 530, a loop including steps 540-590 is performed to build a credits-based lookup table for each computing element as a source computing element in the integrated circuit. At step 540, a loop including steps 550-580 is performed for each destination computing element relative to the current computing element as a source. At step 550, the distance from the current source computing element to the current destination computing element is determined. The distance may include distances in each dimension of the bus interconnect, such as an x-dimension, y-dimension, and z-dimension in a three-dimensional interconnect. The distances may be determined based on a number of arbiters between the computing elements and/or a number of cycles required for a packet to travel from the source to the destination.

At step 560, one of the functions defined at step 510 may be applied to compute a number of credits for the current source computing element relative to the current destination computing element. In at least one aspect, the functions for each phase of the bus transaction may be applied to determine the respective number of credits for each phase of the bus transaction. In one aspect, the number of credits may be a total number of credits for all dimensions of the bus interconnect. In such an aspect, the priority manager 201 may tag a packet with an indication of the total number of credits. In other aspects, the functions may be invoked using the distances in each dimension to compute a number of credits for each dimension in the interconnect. At step 570, an indication of the computed numbers of credits may be stored in the credit-based lookup table for the current source computing element.

Step 580 of the method 500 includes a determination as to whether more destination computing elements remain relative to the current source computing element. If more destination computing elements remain, the method returns to step 540. If no more destination computing elements remain, credits for each destination computing element relative to the current source computing element have been computed, and the method proceeds to step 590. At step 590, the credit-based lookup tables may be stored in the source interface 102 (and/or the computing element 101) as lookup tables 202. Step 595 of the method 500 includes a determination of whether more source computing elements in the integrated circuit remain. If more source computing elements remain, the method 500 returns to step 530 to build credit-based lookup tables for the remaining source computing elements. Otherwise, the method 500 ends.

FIG. 6 is a flow chart illustrating a method 600 corresponding to step 340 to configure arbiters to perform arbitration operations based on indications of priority stored in packets, according to one aspect. Generally, the steps of the method 600 describe techniques used to design arbiters 205 that control access to a bus interconnect that implements multi-stage bus arbitration. As shown, the method 600 begins at step 610, where a loop including steps 620-680 is performed for each arbiter 205 being designed in an integrated circuit, such as a SoC. At step 620, logic to convert between credit-based and priority-class based implementations is provided in the arbiter 205 (and/or the router 103). An example of such logic is the arbitration manager 204, which is configured to convert priority classes to credits and convert credits to priority classes. For example, the arbitration manager 204 may convert a priority class of 0 to 1 credit, and convert 6 credits to a priority class of 2.

At step 630, the current arbiter 205 is configured to apply credit-based arbitration or priority class-based arbitration. While either scheme may be applied by any arbiter 205, in some aspects, the location of the arbiter 205 in the topology lends itself to favoring one scheme over the other. For example, for arbiters 205 (or routers 103) in the center of the topology, it may be more advantageous to configure the arbiters 205 to apply the priority class scheme. Similarly, for arbiters 205 (or routers 103) located near endpoints (e.g., computing elements 101), it may be more advantageous to apply the priority class scheme. As another example, the credit-based scheme may be more appropriate for intermediate arbiters 205 that are situated along the path between endpoints and the center of the topology. As previously indicated, however, some arbiters 205 in a given router 103 may apply the credit scheme, while other arbiters in the router 103 may apply the priority class scheme.

If the current arbiter 205 is configured as a credit-based arbiter, the method proceeds to step 640, where the current arbiter 205 is configured to compare indications of the number of credits in each packet in the input ports of the arbiter 205. The current arbiter 205 is further configured to serve the packet having the highest number of credits in a given cycle. In at least one aspect, the arbitration logic 212 of the arbiters 205 are configured to perform the comparison of credits and serve the input port having the packet with the highest number of credits. The arbitration logic 212 may further be configured to identify the credits for the appropriate dimension of the interconnect. For example, if the current arbiter 205 controls access to the y-dimension of the interconnect, the arbitration logic 212 may identify the y-dimension credits in the packet.

If the current arbiter 205 is a credit-based arbiter, the method proceeds to step 650, where the current arbiter 205 is configured to optionally change the number of credits of a packet that is served by the arbiter 205. For example, the current arbiter 205 may increment or decrement the number of credits of the packet by a predefined number of credits. The predefined number of credits may be based on the complexity and/or the location of the current arbiter 205 in the topology. The predefined number of credits may also be based on the dimension of the interconnect being controlled by the current arbiter 205. The arbitration logic 212 (and/or the arbitration manager 204) may be configured to decrement or increments the credits by the predefined number of credits, and store an indication of the updated number of credits in the packet once the credits have been changed. The arbitration logic 212 may further update the credits of the appropriate dimension, in aspects where credits for each dimension are specified in the packet. Similarly, the arbiter 205 may be configured to not modify the number of credits before forwarding the packet. As previously indicated, in changing the number of credits for the packet, the arbiter 205 may apply an algorithm to recompute a new number of credits for the packet in one or more dimensions, and store the updated numbers of credits in the packet. Once number of credits has optionally been changed, the method proceeds to step 670.

Returning to step 630, if the current arbiter 205 is a priority class-based arbiter, the method proceeds to step 660, where the current arbiter 205 may be configured to compare the indications of priority classes of the packets in each input port of the arbiter 205. The arbiter 205 may further be configured to serve the packet having the highest priority class in a given cycle. In at least one aspect, the arbitration logic 212 of the arbiter 205 is configured to perform the arbitration operations based on a comparison of priority classes, serving the packet with the highest priority class. In aspects where the packet is tagged with an indication of a priority class for each dimension of the interconnect, the arbitration logic 212 is configured to compare the priority classes corresponding to the dimension of the interconnect controlled by the current arbiter 205. At step 665, the current arbiter 205 may be configured to optionally change the priority class of served data packet. For example, the arbiter 205 may apply an algorithm to compute an updated priority class for the served data packet. The method then proceeds to step 670.

At step 670, the arbitration logic 212 of the current arbiter 205 is configured to perform fair arbitration in the event of ties between the priority of packets (e.g., numbers of credits or priority classes). At step 680, if more arbiters remain in the topology, the method returns to step 610. Otherwise, if no more arbiters remain, the method 600 ends.

FIG. 7 is a flow chart illustrating a method 700 corresponding to step 350 to process bus transactions, according to one aspect. Generally, the steps of the method 700 depict a series of operations performed by components of a SoC as part of bus transactions. As shown, the method 700 begins at step 710, where a source computing element generates a first packet targeting the bus interconnect. The first packet may correspond to a particular phase of the bus transaction. The interface 101 may then receive the first packet from the source. At step 720, the priority manager 201 of the interface 101 to the bus 104 may reference the lookup table 202 corresponding to the phase of the bus transaction, and insert one or more indications of priority into the first packet. For example, the priority manager 201 may identify the destination specified in the first packet, and reference the appropriate lookup table 202 using the destination as an index. The priority manager 201 may then identify a number of credits and/or a priority class specified in the corresponding entry for the destination in the lookup table 202. The priority manager 201 may then insert an indication of the number of credits and/or the priority class into the first packet. In at least one aspect, the priority manager 201 may insert indications of priority for each dimension of the bus interconnect into the first packet. In at least one aspect, the indications of priority for each dimension may include credits for at least one dimension of the interconnect, and priority classes for at least one other dimension of the interconnect.

At step 730, a loop including steps 740-790 is performed for each arbiter 205 (or router) disposed between the source computing element and the destination computing element of the first packet. At step 740, the current arbiter receives data packets, including the first data packet, in the input ports of the current arbiter 205. At step 750, the arbitration manger 204 may optionally convert credits to a priority class or convert a priority class to credits, as the case may be, to ensure that the first packet includes an indication of priority that can be used by the current arbiter as part of an arbitration operation.

Generally, each of the packets may target a respective output port of the current arbiter 205. Therefore, the current arbiter 205 must perform an arbitration operation to serve the packets and grant packets access to the output port one packet per cycle. The arbitration operation is based on the type of the current arbiter (credit based or priority class based). If the current arbiter 205 is a priority class-based arbiter, the method proceeds to step 760, where the current arbiter 205 serves the packet with the highest priority based on a comparison of the priority classes specified in each packet until the first packet is served, granting the first packet access to the output port of the current arbiter 205. In at least one aspect, the arbitration logic 212 of the arbiter 205 performs the arbitration operation by comparing the priority classes specified in each packet. The arbitration logic 212 may then determine which packet has the highest priority class, and grant the packet having the highest priority class access to the output port. At step 765, the current arbiter 205 may optionally modify the priority class of the first packet. For example, the current arbiter 205 may optionally increase or decrease the priority class of the current packet. The method may then proceed to step 790.

Returning to step 750, if the current arbiter is credit-based, the method proceeds to step 770, where the current arbiter 205 serves the packet with the highest priority based on a comparison of the number of credits in the packets until the first packet is served. In at least one aspect, the arbitration logic 212 of the arbiter 205 performs the arbitration operation by comparing the numbers of credits specified in each packet. The arbitration logic 212 may then determine which packet has the highest number of credits, and grant the packet having the highest number of credits access to the output port. At step 780, the credit-based arbiter 205 may decrement the first packet by a predefined number of credits. The number of credits decremented from the first packet may be a static number of credits specific to the current arbiter 205. In addition, the current arbiter 205 may recompute the number of credits for the current packet. For example, if the packet has zero credits (pre-decrementing or post-decrementing), the current arbiter may recomputed a number of credits for the packet based on distance to destination before forwarding the packet. The current arbiter 205 may also store an indication of an updated number of credits (decremented, unaltered, or recomputed) in the first packet before forwarding the packet on the bus 104. At step 790, if the first packet is received at a next arbiter, the method returns to step 730. If no more arbiters remain between the source and destination, at step 795, the first packet is received at its destination.

FIG. 8 is a block diagram illustrating a computing device 801 integrating the system on a chip (SoC) 100 having a bus interconnect 104 configured to provide quality of service, according to one aspect. All of the apparatuses and methods depicted in FIGS. 1-7 may be included in or performed by the computing device 801. The computing device 801 may also be connected to other computing devices via a network 830. In general, the network 830 may be a telecommunications network and/or a wide area network (WAN). In a particular aspect, the network 830 is the Internet. Generally, the computing device 801 may be any device which includes a bus interconnect that performs multi-stage arbitration and applies quality of service, including, without limitation, a server, a desktop computer, a laptop computer, a tablet computer, and a smart phone.

The computing device 801 generally includes the SOC 100, which includes a processor 804 connected via the bus 104 to a memory 808, a network interface device 818, a storage 809, an input device 822, and an output device 824. The computing device 801 is generally under the control of an operating system (not shown). Any operating system supporting the functions disclosed herein may be used. The processor 804 is included to be representative of a single CPU, multiple CPUs, a single CPU having multiple processing cores, and the like. The network interface device 818 may be any type of network communications device allowing the computing device 801 to communicate with other computing devices via the network 830.

The storage 809 may be a persistent storage device. Although the storage 809 is shown as a single unit, the storage 809 may be a combination of fixed and/or removable storage devices, such as fixed disc drives, solid state drives, SAN storage, NAS storage, removable memory cards or optical storage. The memory 808 and the storage 809 may be part of one virtual address space spanning multiple primary and secondary storage devices.

The input device 822 may be any device for providing input to the computing device 801. For example, a keyboard and/or a mouse may be used. The output device 824 may be any device for providing output to a user of the computing device 801. For example, the output device 824 may be any conventional display screen or set of speakers. Although shown separately from the input device 822, the output device 824 and input device 822 may be combined. For example, a display screen with an integrated touch-screen may be used.

As shown, the computing device 801 includes a plurality of interfaces 102 and routers 103, described in greater detail above. Generally, the interfaces 102 connect computing elements (such as the processor 804, memory 806, storage 808, network interface 818, input device 822, and output device 824) to the bus 104, and may tag packets generated by the computing elements with an indication of priority (e.g., credits and/or priority class). The routers 103 are generally configured to control access to the bus 104 by packets generated by the computing elements by providing arbiters 205 configured to compare the indications of priority in each packet.

Advantageously, aspects disclosed herein provide quality of service to bus interconnects implementing multi-stage arbitration in an integrated circuit such as a system on a chip (SoC). Generally, priority classes and/or credits are assigned to a packet at the source based on a distance to the destination of the packet. Advantageously, aspects disclosed herein provide the ability to assign separate priority classes and/or credits for each dimension of the bus interconnect. Furthermore, the source computing elements may include different lookup tables for each phase of a bus transaction. Advantageously, arbiters controlling access to the bus interconnect may apply either scheme, as aspects disclosed herein provide the ability to swap between schemes along the path traveled by packets.

A number of aspects have been described. However, various modifications to these aspects are possible, and the principles presented herein may be applied to other aspects as well. The various tasks of such methods may be implemented as sets of instructions executable by one or more arrays of logic elements, such as microprocessors, embedded controllers, or IP cores.

The various operations of methods described above may be performed by any suitable means capable of performing the operations, such as a processor, firmware, application specific integrated circuit (ASIC), gate logic/registers, memory controller, or a cache controller. Generally, any operations illustrated in the Figures may be performed by corresponding functional means capable of performing the operations.

The foregoing disclosed devices and functionalities may be designed and configured into computer files (e.g. RTL, GDSII, GERBER, etc.) stored on computer readable media. Some or all such files may be provided to fabrication handlers who fabricate devices based on such files. Resulting products include semiconductor wafers that are then cut into semiconductor die and packaged into a semiconductor chip. Some or all such files may be provided to fabrication handlers who configure fabrication equipment using the design data to fabricate the devices described herein. Resulting products formed from the computer files include semiconductor wafers that are then cut into semiconductor die (e.g., the integrated circuit 101) and packaged, and may be further integrated into products including, but not limited to, mobile phones, smart phones, laptops, netbooks, tablets, ultrabooks, desktop computers, digital video recorders, set-top boxes and any other devices where integrated circuits are used.

In one aspect, the computer files form a design structure including the circuits described above and shown in the Figures in the form of physical design layouts, schematics, a hardware-description language (e.g., Verilog, VHDL, etc.). For example, design structure may be a text file or a graphical representation of a circuit as described above and shown in the Figures. Design process preferably synthesizes (or translates) the circuits described below into a netlist, where the netlist is, for example, a list of wires, transistors, logic gates, control circuits, I/O, models, etc. that describes the connections to other elements and circuits in an integrated circuit design and recorded on at least one of machine readable medium. For example, the medium may be a storage medium such as a CD, a compact flash, other flash memory, or a hard-disk drive. In another aspect, the hardware, circuitry, and method described herein may be configured into computer files that simulate the function of the circuits described above and shown in the Figures when executed by a processor. These computer files may be used in circuitry simulation tools, schematic editors, or other software applications.

The implementations of aspects disclosed herein may also be tangibly embodied (for example, in tangible, computer-readable features of one or more computer-readable storage media as listed herein) as one or more sets of instructions executable by a machine including an array of logic elements (e.g., a processor, microprocessor, microcontroller, or other finite state machine). The term “computer-readable medium” may include any medium that can store or transfer information, including volatile, nonvolatile, removable, and non-removable storage media. Examples of a computer-readable medium include an electronic circuit, a semiconductor memory device, a ROM, a flash memory, an erasable ROM (EROM), a floppy diskette or other magnetic storage, a CD-ROM/DVD or other optical storage, a hard disk or any other medium which can be used to store the desired information, a fiber optic medium, a radio frequency (RF) link, or any other medium which can be used to carry the desired information and can be accessed. The computer data signal may include any signal that can propagate over a transmission medium such as electronic network channels, optical fibers, air, electromagnetic, RF links, etc. The code segments may be downloaded via computer networks such as the Internet or an intranet. In any case, the scope of the present disclosure should not be construed as limited by such aspects.

The previous description of the disclosed aspects is provided to enable a person skilled in the art to make or use the disclosed aspects. Various modifications to these aspects will be readily apparent to those skilled in the art, and the principles defined herein may be applied to other aspects without departing from the scope of the disclosure. Thus, the present disclosure is not intended to be limited to the aspects shown herein but is to be accorded the widest scope possible consistent with the principles and novel features as defined by the following claims.

What is claimed is:

1. An integrated circuit, comprising:
a first arbiter for controlling access to a bus interconnect, the first arbiter configured to:
receive a first packet having a first priority at a first input port;
receive a second packet having a second priority, wherein the first and second priorities are based on a distance to a respective destination of the first and second packets; and
forward the first packet upon determining that the first priority is of a higher relative priority than the second priority.

2. The integrated circuit of claim 1, wherein:
the first priority comprises a first number of credits;
the second packet is received at a second input port of the first arbiter;
the second priority comprises a second number of credits; and
the first arbiter is configured to make the determination that the first packet has a higher relative priority than the second packet based on a comparison of the first and second numbers of credits.

3. The integrated circuit of claim 2, wherein the first arbiter is further configured to:
decrement the first number of credits of the first packet by a predefined number of credits; and
store an indication of the first number of credits in the first packet prior to forwarding the first packet.

4. The integrated circuit of claim 2, further comprising:
a source computing element configured to generate the first packet; and
an interface connecting the source computing element to the bus interconnect, wherein the interface comprises a priority manager configured to:
identify the first number of credits in a lookup table stored in the interface, wherein the first number of credits is based on at least one of: (i) a distance from the source computing element to a destination of the first packet, (ii) a bandwidth of the bus interconnect, and (iii) a time required for the first packet to travel from the source computing element to the destination; and
insert an indication of the computed first number of credits in the first packet.

5. The integrated circuit of claim 2, further comprising an arbitration manager configured to:
compute a first priority class for the first packet based on the first number of credits; and
compute a second priority class for the second packet based on the second number of credits,
wherein the first arbiter is configured to make the determination based on a comparison of the first and second priority classes.

6. The integrated circuit of claim 1, wherein:
the first priority comprises a first priority class;
the second priority comprises a second priority class; and
the first arbiter is configured to make the determination that the first packet has a higher relative priority than the second packet based on a comparison of the first and second priority classes.

7. The integrated circuit of claim 6, further comprising:
a source computing element configured to generate the first packet, wherein the first packet specifies: (i) the source computing element as a source of the first packet, and (ii) a first destination computing element, of a plurality of computing elements of the integrated circuit, as a destination of the first packet; and
an interface connecting the source computing element to the bus interconnect, wherein the interface comprises a priority manager configured to:
identify the first priority class in a routing table of the interface, wherein the first priority class is defined based on a distance from the first source computing element to the first destination computing element; and
insert an indication of the first priority class in the first packet.

8. The integrated circuit of claim 7, wherein the interface is integrated in the source computing element, wherein the first priority class is based on a distance from the first source computing element to the first destination computing element, wherein the second priority class is based on a distance from a second source computing element to a second destination computing element, of the plurality of computing elements.

9. The integrated circuit of claim 8, wherein the distance from the first source computing element to the first destination computing element is based on at least one of:
(i) a number of arbiters, of a plurality of arbiters, disposed between the first source computing element and the first destination computing element, (ii) a number of cycles required for the first packet to travel from the first source computing element to the first destination computing element, and (iii) an amount of time required for the first packet to travel from the first source computing element to the first destination computing element.

10. The integrated circuit of claim 6, further comprising an arbitration manager configured to:
compute a first number of credits for the first packet based on the first priority class; and
compute a second number of credits of the second packet based on the second priority class,
wherein the first arbiter is configured to make that the first packet has a higher relative priority than the second packet based on a comparison of the first and second number of credits.

11. A method, comprising:
receiving a first packet having a first priority at a first arbiter configured to control access to a bus interconnect;
receiving, by the first arbiter, a second packet having a second priority, wherein the first and second priorities are based on a distance to a respective destination of the first and second packets; and
forwarding, by the first arbiter, the first packet upon determining that the first priority is of a higher relative priority than the second priority.

12. The method of claim 11, wherein:
the first priority comprises a first number of credits;
the second packet is received at a second input port of the first arbiter;
the second priority comprises a second number of credits; and
the first arbiter is configured to make the determination that the first packet has a higher relative priority than the second packet based on a comparison of the first and second numbers of credits.

13. The method of claim 12, further comprising:
decrementing, by the first arbiter, the first number of credits of the first packet by a predefined number of credits; and
storing, by the first arbiter, an indication of the first number of credits in the first packet prior to forwarding the first packet.

14. The method of claim 12, wherein a source computing element generates the first packet, wherein an interface connects the source computing element to the bus interconnect, wherein the interface is configured to perform an operation comprising:
identifying the first number of credits in a lookup table stored in the interface, wherein the first number of credits is based on at least one of: (i) a distance from the source computing element to a destination of the first packet, (ii) a bandwidth of the bus interconnect, and (iii) a time required for the first packet to travel from the source computing element to the destination; and
inserting an indication of the computed first number of credits in the first packet.

15. The method of claim 12, further comprising:
computing a first priority class for the first packet based on the first number of credits; and
computing a second priority class for the second packet based on the second number of credits,
wherein the first arbiter is configured to make the determination based on a comparison of the first and second priority classes.

16. The method of claim 11, wherein:
the first priority comprises a first priority class;
the second priority comprises a second priority class; and
the first arbiter is configured to make the determination that the first packet has a higher relative priority than the second packet based on a comparison of the first and second priority classes.

17. The method of claim 16, wherein a source computing element generates the first packet, wherein an interface connects the source computing element to the bus interconnect, wherein the interface is configured to perform an operation comprising:
identifying the first priority class in a routing table of the interface, wherein the first priority class is defined based on a distance from the first source computing element to a first destination computing element; and
inserting an indication of the first priority class in the first packet.

18. The method of claim 17, wherein the interface is integrated in the source computing element, wherein the first priority class is based on a distance from the first source computing element to the first destination computing element, wherein the second priority class is based on a distance from a second source computing element to a second destination computing element, of the plurality of computing elements.

19. The method of claim 18, wherein the distance from the first source computing element to the first destination computing element is based on at least one of: (i) a number of arbiters, of a plurality of arbiters, disposed between the first source computing element and the first destination computing element, (ii) a number of cycles required for the first packet to travel from the first source computing element to the first destination computing element, and (iii) an amount of time required for the first packet to travel from the first source computing element to the first destination computing element.

20. The method of claim 16, further comprising:
computing a first priority class for the first packet based on the first number of credits; and
computing a second priority class for the second packet based on the second number of credits,
wherein the first arbiter is configured to make the determination based on a comparison of the first and second priority classes.

21. An integrated circuit, comprising:
a first computing element configured to generate a first packet specifying the first computing element as a source and a second computing element as a destination; and
a first interface coupled to the first computing element and configured to:
identify, in a routing table of the first interface, a priority for the first packet, wherein the priority is based on a distance from the first computing element to the second computing element; and
insert an indication of the priority in the first packet.

22. The integrated circuit of claim 21, wherein the indication of the priority comprises a first priority class, of a plurality of priority classes, wherein the first priority class is based on the distance from the first computing element to the second computing element, wherein the first interface connects the first computing element to a bus interconnect, wherein the first interface is integrated in the first computing element.

23. The integrated circuit of claim 22, further comprising a plurality of arbiters configured to control access to the bus interconnect by the computing elements, wherein the distance from the first computing element to the second computing element is based on at least one of: (i) a number of arbiters, of the plurality of arbiters, disposed between the first computing element and the second computing element, (ii) a number of cycles required for the first packet to travel from the first computing element to the second computing element, and (iii) an amount of time required for the first packet to travel from the first computing element to the second computing element.

24. The integrated circuit of claim 23, wherein a first arbiter of the plurality of arbiters is configured to:
receive the first packet at a first input port;
receive a second packet at a second input port, wherein the second packet specifies a second priority class; and
forward the first packet via an output port of the first arbiter upon determining that the first priority class is of a higher priority than the second priority class.

25. The integrated circuit of claim 24, further comprising an arbitration manager configured to:
compute a first number of credits for the first packet based on the first priority class; and
compute a second number of credits for the second packet based on the second priority class.

26. The integrated circuit of claim 25, wherein a second arbiter of the plurality of arbiters is configured to:
receive the first packet by a first input port;
receive the second packet by a second input port; and
forward the first packet via an output port upon determining the first packet has a higher relative priority than the second packet based on a comparison of the first and second numbers of credits.

27. The integrated circuit of claim 21, wherein the indication of the priority comprises a first number of credits, wherein the first number of credits is based on at least one of: (i) the distance from the first computing element to the second computing element, (ii) a bandwidth of the bus interconnect, and (iii) a time required for the first packet to travel from the first computing element to the second computing element, wherein the first interface connects the first computing element to a bus interconnect, wherein the first interface is integrated in the first computing element.

28. The integrated circuit of claim 27, further comprising a plurality of arbiters configured to control access to the bus interconnect by the plurality of computing elements, wherein a first arbiter of the plurality of arbiters is configured to:
receive the first packet at a first input port;
receive a second packet at a second input port, wherein the second packet specifies a second number of credits; and
forward the first packet via an output port of the first arbiter based on a comparison of the first and second numbers of credits.

29. The integrated circuit of claim 28, further comprising logic configured to:
decrement the first number of credits of the first packet by a predefined number of credits; and
store an indication of the first number of credits in the first packet prior to forwarding the first packet to the first destination.

30. The integrated circuit of claim 29, further comprising logic configured to:
compute a first priority class for the first packet based on the first number of credits; and
compute a second priority class for the second packet based on the second number of credits.

31. The integrated circuit of claim 30, wherein a second arbiter, of the plurality of arbiters, is configured to:
receive the first packet by a first input port;
receive the second packet by a second input port; and
forward the first packet via an output port of the second arbiter upon determining the first packet has a higher relative priority than the second packet based on a comparison of the first and second priority classes.

32. A method, comprising:
generating, by a first computing element, a first packet specifying the first computing element as a source and a second computing element as a destination; and
identifying, in a routing table of a first interface coupled to the first computing element, a priority for the first packet, wherein the priority is based on a distance from the first computing element to the second computing element; and
inserting, by the first interface, an indication of the priority in the first packet.

33. The method of claim 32, wherein the indication of the priority comprises a first priority class, of a plurality of priority classes, wherein the first priority class is based on the distance from the first computing element to the second computing element, wherein the first interface connects the first computing element to a bus interconnect, wherein the first interface is integrated in the first computing element.

34. The method of claim 33, wherein a plurality of arbiters are configured to control access to the bus interconnect by the computing elements, wherein the distance from the first computing element to the second computing element is based on at least one of: (i) a number of arbiters, of the plurality of arbiters, disposed between the first computing element and the second computing element, (ii) a number of cycles required for the first packet to travel from the first computing element to the second computing element, and (iii) an amount of time required for the first packet to travel from the first computing element to the second computing element.

35. The method of claim 34, further comprising:
receiving the first packet at a first input port of a first arbiter of the plurality of arbiters;
receiving a second packet at a second input port of the first arbiter, wherein the second packet specifies a second priority class; and
forwarding the first packet via an output port of the first arbiter upon determining that the first priority class is of a higher priority than the second priority class.

36. The method of claim 35, further comprising:
computing a first number of credits for the first packet based on the first priority class; and
computing a second number of credits for the second packet based on the second priority class.

37. The method of claim 36, further comprising:
receiving the first packet by a first input port of a second arbiter, of the plurality of arbiters;
receive the second packet by a second input port of the second arbiter; and
forward the first packet via an output port of the second arbiter upon determining the first packet has a higher relative priority than the second packet based on a comparison of the first and second numbers of credits.

38. The method of claim 32, wherein the indication of the priority comprises a first number of credits, wherein the first number of credits is based on at least one of: (i) the distance from the first computing element to the second computing element, (ii) a bandwidth of the bus interconnect, and (iii) a time required for the first packet to travel from the first computing element to the second computing element, wherein the first interface connects the first computing element to a bus interconnect, wherein the first interface is integrated in the first computing element.

39. The method of claim 38, wherein a plurality of arbiters are configured to control access to the bus interconnect by the computing elements, the method further comprising:
receiving the first packet at a first input port of a first arbiter, of the plurality of arbiters;
receiving a second packet at a second input port of the first arbiter, wherein the second packet specifies a second number of credits; and
forwarding the first packet via an output port of the first arbiter based on a comparison of the first and second numbers of credits.

40. The method of claim 39, further comprising:
decrementing the first number of credits of the first packet by a predefined number of credits; and
storing an indication of the first number of credits in the first packet prior to forwarding the first packet to the first destination.

41. The method of claim 40, further comprising:
computing a first priority class for the first packet based on the first number of credits;
computing a second priority class for the second packet based on the second number of credits;
receiving the first packet by a first input port of a second arbiter, of the plurality of arbiters;
receiving the second packet by a second input port of the second arbiter; and
forward the first packet via an output port of the second arbiter upon determining the first packet has a higher relative priority than the second packet based on a comparison of the first and second priority classes.

42. An apparatus, comprising:
means for receiving a first packet having a first priority;
means for receiving a second packet having a second priority, wherein the first and second priorities are based on a distance to a respective destination of the first and second packets; and
means for forwarding the first packet upon determining that the first priority is of a higher relative priority than the second priority.

43. An apparatus, comprising:
means for generating a first packet specifying a first computing element, of a plurality of computing elements connected via a bus interconnect, as a source and a second computing element of the plurality of computing elements as a destination;
means for identifying a priority for the first packet, wherein the priority is based on a distance from the first computing element to the second computing element; and
means for inserting an indication of the priority in the first packet.
